(19) United States
(12) Patent Application Publication
(10) Pub. No.: US 2015/0051867 A1
(43) Pub. Date: Feb. 19, 2015

(54) Pedometer apparatus with tone code technology for wireless data transmission function

(71) Applicant: Chun Kwong CHOI, Fo Tan (HK)

(72) Inventor: Chun Kwong CHOI, Fo Tan (HK)

(21) Appl. No.: 13/965,213

(22) Filed: Aug. 13, 2013

(51) Int. Cl. G01C 22/00; H04B 11/00; H04B 1/034

(52) U.S. Cl. CPC G01C 22/006; H04B 1/0343; H04B 11/00
USPC 702/160

(57) ABSTRACT

A pedometer apparatus with wireless data transmission function includes a transmitting member and a receiving member. The transmitting member includes a step counting means, a first microprocessor and an audio transmitter. The receiving member includes a microphone module, a second microprocessor and a data output means. The present invention is susceptible to low production costs, requires low power consumption and is easy and convenient to use.

### BACKGROUND OF THE INVENTION

The present invention relates to a pedometer and more specifically relates to a pedometer apparatus with wireless data transmission function using tone code technology.

As public awareness towards personal health increases, health care products are getting more and more popular. An example of such health care products is a pedometer which counts the number of steps a person takes. A conventional pedometer is usually worn on a user's wrist or attached to a user's belt or shoe, and is disposed with an accelerometer therein; the microprocessor of the pedometer runs a computer program to obtain data from the accelerometer and calculate the number of steps taken and the results are then output on the display screen of the pedometer.

Users usually prefer the pedometers to be as compact and light-weight as possible. However, conventional pedometers disposed with accelerometers, microprocessors and display screens are usually too large and heavy to fulfill users' needs. The marketplace also provides pedometers with wireless transmission modules such as Bluetooth, RF or Wi-Fi modules for transmitting data obtained by the built-in accelerometer to an external device such as a smartphone or a desktop computer; the external device then processes the data and outputs the results to the users. As the complicated calculating function is performed in the external device, fewer components are required to be disposed in the pedometer and thus the weight and power consumption of the pedometer could be reduced in comparison with the aforementioned conventional pedometers. However, such wireless transmission module also incurs high material costs and requires high power consumption; besides, complex procedure for pairing the pedometer with the external device is required before users could use the pedometer, thus bringing much inconvenience to users.

### BRIEF SUMMARY OF THE INVENTION

In view of the aforesaid disadvantages now present in the prior art, it is an object of the present invention to provide a pedometer apparatus with tone code technology for wireless data transmission function which is susceptible to low production costs, requires low power consumption and is easy and convenient to use.

To attain this, the present invention comprises

a transmitting member comprising a step counting means which senses motion of a user and calculates number of steps taken by the user, a first microprocessor which is electrically connected to the step counting means and encodes the number of steps calculated by the step counting means to output corresponding electrical signals according to predetermined algorithm and thereafter drives an audio transmitter which is electrically connected to the first microprocessor to generate high frequency audio tones according to the electrical signals output by the first microprocessor;

a receiving member comprising a microphone module for receiving audio input signals and converting the received audio input signals to output digital signals, a second microprocessor which runs an application program to activate the microphone module, process the digital signals output by the microphone module, recognize the digital signals which correspond to the high frequency audio tones generated by the audio transmitter, decode the recognized digital signals according to predetermined algorithm to output the number of steps taken by the user, and drive a data output means to output the number of steps taken by the user.

The transmitting member is also disposed with a switch which is electrically connected to the first microprocessor and controls operation of the first microprocessor.

The step counting means comprises an accelerometer.

The high frequency audio tones are in range of 17 kHz to 19 kHz; the present invention has a working distance of 1 cm to 30 cm between the transmitting member and the receiving member.

In one embodiment, the first microprocessor encodes the number of steps in such a way that an audio tone of a specific frequency correspond to each digit of 0 to 9; the number of steps is represented by a sequence of digits and the sequence of digits is represented by a corresponding sequence of audio tones.

In one embodiment, the number of steps taken by the user accumulates in the step counting means until a predetermined limit is reached; the receiving member further comprises a memory which is initially set to a value of 0; the application program in the receiving member is configured to calculate the number of steps taken by the user during a period of time by subtracting the number of steps stored in the memory of the receiving member from the number of steps accumulated in the step counting means as transmitted from the transmitting member; the number of steps accumulated in the step counting means as transmitted from the transmitting member then replaces the value stored in the memory of the receiving member for calculating the number of steps taken by the user during a subsequent period of time.

The audio transmitter is in form of a speaker, a buzzer or a transducer.

The transmitting member is housed within a compact casing in shape of a bracelet for wearing on the user's wrist, or within a casing with a clip for attaching to the user's clothes.

The receiving member is in form of a smartphone.

The data output means is in form of a display screen or a speaker.

The present invention is operated as follows:

The user first activates the transmitting member and carries the transmitting member with him, for example by wearing it on his wrist or attaching it to his clothes. The step counting means of the transmitting member then senses the motion of the user and calculates the number of steps taken by the user. If the user wishes to know the number of steps he has taken, the user presses the switch to activate the first microprocessor to encode the number of steps calculated by the step counting means to output corresponding electrical signals according to predetermined algorithm and thereafter drives the audio transmitter which is electrically connected to the first microprocessor to generate high frequency audio tones according to the electrical signals output by the first microprocessor. At the same time, the user runs the application program in the receiving member so that the microphone module is activated to receive audio input signals from the ambient environment and convert the received audio input signals to output digital signals; the digital output signals output by the microphone module are then processed by the second microprocessor which then recognizes the digital signals which correspond to the high frequency audio tones generated by the audio transmitter, decodes the recognized digital signals according to predetermined algorithm to output the number of steps taken by the user, and drives the data output means to output the number of steps taken by the user. The number of steps accumulated in the step counting means as transmitted from the transmitting member then replaces the value stored in a memory of the receiving member, which is initially set to 0, for calculating the number of steps taken by the user during a subsequent period of time.

As the user continues to carry the transmitting member, the step counting means of the transmitting member continues to sense the motion of the user, and the number of steps accumulates in the step counting means until it reaches a predefined limit, e.g. 999,999,999. After a period of time when the user wishes to know the number of steps he has taken during that period of time, the user presses the switch again; the number of steps accumulated in the step counting means is transmitted from the transmitting member to the receiving member, and the application program in the receiving member is configured to calculate the number of steps taken by the user during the period of time by subtracting the number of steps stored in the memory of the receiving member from the number of steps accumulated in the step counting means as transmitted from the transmitting member. The number of steps accumulated in the step counting means as transmitted from the transmitting member then replaces the value stored in the memory of the receiving member for calculating the number of steps taken by the user during a subsequent period of time.

It should be understood that the step counting means, the audio transmitter as well as the microphone module are widely available in the marketplace and so no further details on the operation thereof are provided herein.

### BRIEF DESCRIPTION OF THE DRAWINGS

FIG. 1 illustrates a block diagram of the present invention according to one embodiment.

### DETAILED DESCRIPTION OF THE INVENTION

The present invention is further described below with reference to but not limited to an embodiment and the accompanying drawings.

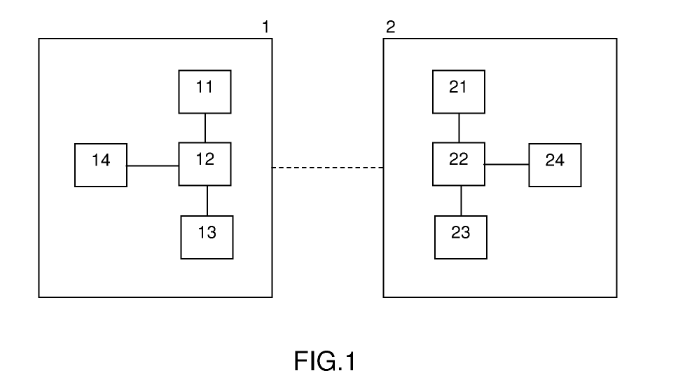

As illustrated in FIG. 1, the pedometer apparatus of the present invention comprises a transmitting member 1 and a receiving member 2.

The transmitting member 1 comprises a step counting means 11 which senses motion of a user and calculates number of steps taken by the user, a first microprocessor 12 which is electrically connected to the step counting means 11 and encodes the number of steps calculated by the step counting means 11 to output corresponding electrical signals according to predetermined algorithm and thereafter drives an audio transmitter 13 which is electrically connected to the first microprocessor 12 to generate high frequency audio tones according to the electrical signals output by the first microprocessor 12. The transmitting member 1 is also disposed with a switch 14 which is electrically connected to the first microprocessor 12 and controls operation of the first microprocessor 12. The step counting means 11 in this embodiment comprises an accelerometer.

In this embodiment, the high frequency audio tones are in range of 17 kHz to 19 kHz, and the present embodiment has a working distance of 1 cm to 30 cm between the transmitting member and the receiving member. The first microprocessor 12 encodes the number of steps in such a way that an audio tone of a specific frequency correspond to each digit of 0 to 9; more specifically, the audio tone of 17 kHz is assigned for the digit 0; the audio tone of 17.2 kHz is assigned for the digit 1; the audio tone of 17.4 kHz is assigned for the digit 2; the audio tone of 17.6 kHz is assigned for the digit 3; the audio tone of 17.8 kHz is assigned for the digit 4; the audio tone of 18 kHz is assigned for the digit 5; the audio tone of 18.2 kHz is assigned for the digit 6; the audio tone of 18.4 kHz is assigned for the digit 7; the audio tone of 18.6 kHz is assigned for the digit 8; the audio tone of 18.8 kHz is assigned for the digit 9. The number of steps is represented by a sequence of digits and the sequence of digits is represented by a corresponding sequence of audio tones. For example, 100 steps would be represented by a sequence of digits 000000100, and the sequence of digits 000000100 is represented by a corresponding sequence of audio tones which has the frequencies of 17 kHz, 17 kHz, 17 kHz, 17 kHz, 17 kHz, 17 kHz, 17.2 kHz, 17 kHz, 17 kHz in sequence.

The audio transmitter 13 is in form of a buzzer in the present embodiment, but may also be in form of a speaker or a transducer in other embodiments. The transmitting member 1 is housed within a compact casing in shape of a bracelet for wearing on the user's wrist in this embodiment, but may also be housed within a casing with a clip for attaching to the user's clothes in other embodiments.

The receiving member 2 comprises a microphone module 21 for receiving audio input signals and converting the received audio input signals to output digital signals, a second microprocessor 22 which runs an application program to activate the microphone module 21, process the digital signals output by the microphone module 21, recognize the digital signals which correspond to the high frequency audio tones generated by the audio transmitter 13, decode the recognized digital signals according to predetermined algorithm to output the number of steps taken by the user, and drive a data output means 23 to output the number of steps taken by the user. In this embodiment, the receiving member 2 is in form of a smartphone, and the data output means 23 is in form of a display screen.

In this embodiment, the number of steps taken by the user accumulates in the step counting means 11 until a predetermined limit is reached, in this case, 999,999,999. The receiving member 2 further comprises a memory 24 which is initially set to a value of 0. The application program in the receiving member 2 is configured to calculate the number of steps taken by the user during a period of time by subtracting the number of steps stored in the memory 24 of the receiving member 2 from the number of steps accumulated in the step counting means 11 as transmitted from the transmitting member 1; the number of steps accumulated in the step counting means 11 as transmitted from the transmitting member 1 then replaces the value stored in the memory 24 of the receiving member 2 for calculating the number of steps taken by the user during a subsequent period of time.

To operate the pedometer apparatus of the present embodiment, the user first activates the transmitting member 1 (i.e. by placing batteries to the transmitting member 1 and thus providing the power required) and carries the transmitting member 1 with him by wearing it on his wrist. The step counting means 11 of the transmitting member 1 then senses the motion of the user and calculates the number of steps taken by the user. If the user wishes to know the number of steps he has taken, the user presses the switch 14 to activate the first microprocessor 12 to encode the number of steps calculated by the step counting means 11 to output corresponding electrical signals according to predetermined algorithm and thereafter drives the audio transmitter 13 which is electrically connected to the first microprocessor 12 to generate high frequency audio tones according to the electrical signals output by the first microprocessor 12. At the same time, the user runs the application program in the receiving member 2 so that the microphone module 21 is activated to receive audio input signals from the ambient environment and convert the received audio input signals to output digital signals; the digital output signals output by the microphone module 21 are then processed by the second microprocessor 22 which then recognizes the digital signals which correspond to the high frequency audio tones generated by the audio transmitter 13, decodes the recognized digital signals according to predetermined algorithm to output the number of steps taken by the user, and drives the data output means 23 to output the number of steps taken by the user. The number of steps accumulated in the step counting means 11 as transmitted from the transmitting member 1 then replaces the value stored in the memory 24 of the receiving member 2, which is initially set to 0, for calculating the number of steps taken by the user during a subsequent period of time.

As the user continues to carry the transmitting member 1, the step counting means 11 of the transmitting member 1 continues to sense the motion of the user, and the number of steps accumulates in the step counting means 1 until it reaches the predefined limit of 999,999,999. After a period of time when the user wishes to know the number of steps he has taken during that period of time, the user presses the switch 14 again; the number of steps accumulated in the step counting means 11 is transmitted from the transmitting member 1 to the receiving member 2, and the application program in the receiving member 2 is configured to calculate the number of steps taken by the user during the period of time by subtracting the number of steps stored in the memory 24 of the receiving member 2 from the number of steps accumulated in the step counting means 11 as transmitted from the transmitting member 1. The number of steps accumulated in the step counting means 11 as transmitted from the transmitting member 1 then replaces the value stored in the memory 24 of the receiving member 2 for calculating the number of steps taken by the user during a subsequent period of time.

The above embodiment is a preferred form of the present invention. However, the present invention is not limited by the above embodiment. Any substantive or fundamental changes, modifications, replacements, combinations or simplification within the spirit of the present invention are equivalent alternatives and they are all included in the scope of protection of the present invention.

What is claimed is:

1. A pedometer apparatus with tone code technology for wireless data transmission function which comprises:
a transmitting member comprising:
a step counting means which senses motion of a user and calculates number of steps taken by the user;
a first microprocessor which is electrically connected to the step counting means and encodes the number of steps calculated by the step counting means to output corresponding electrical signals according to predetermined algorithm and thereafter drives an audio transmitter which is electrically connected to the first microprocessor to generate high frequency audio tones according to the electrical signals output by the first microprocessor;
a receiving member comprising:
a microphone module for receiving audio input signals and converting the received audio input signals to output digital signals;
a second microprocessor which runs an application program to activate the microphone module, process the digital signals output by the microphone module, recognize the digital signals which correspond to the high frequency audio tones generated by the audio transmitter, decode the recognized digital signals according to predetermined algorithm to output the number of steps taken by the user, and drive a data output means to output the number of steps taken by the user.

2. The pedometer apparatus as in claim 1, wherein the transmitting member is disposed with a switch which is electrically connected to the first microprocessor and controls operation of the first microprocessor.

3. The pedometer apparatus as in claim 1, wherein the step counting means comprises an accelerometer.

4. The pedometer apparatus as in claim 1, wherein the high frequency audio tones are in range of 17 kHz to 19 kHz; the pedometer apparatus has a working distance of 1 cm to 30 cm between the transmitting member and the receiving member.

5. The pedometer apparatus as in claim 1, wherein the first microprocessor encodes the number of steps in such a way that an audio tone of a specific frequency correspond to each digit of 0 to 9; the number of steps is represented by a sequence of digits and the sequence of digits is represented by a corresponding sequence of audio tones.

6. The pedometer apparatus as in claim 1, wherein the number of steps taken by the user accumulates in the step counting means until a predetermined limit is reached; the receiving member further comprises a memory which is initially set to a value of 0; the application program in the receiving member is configured to calculate the number of steps taken by the user during a period of time by subtracting the number of steps stored in the memory of the receiving member from the number of steps accumulated in the step counting means as transmitted from the transmitting member; the number of steps accumulated in the step counting means as transmitted from the transmitting member then replaces the value stored in the memory of the receiving member for calculating the number of steps taken by the user during a subsequent period of time.

7. The pedometer apparatus as in claim 1, wherein the audio transmitter is in form of a speaker, a buzzer or a transducer.

8. The pedometer apparatus as in claim 1, wherein the transmitting member is housed within a compact casing in shape of a bracelet for wearing on the user's wrist, or within a casing with a clip for attaching to the user's clothes.

9. The pedometer apparatus as in claim 1, wherein the receiving member is in form of a smartphone.

10. The pedometer apparatus as in claim 1, wherein the data output means is in form of a display screen or a speaker.
